(19) United States
(12) Patent Application Publication
(10) Pub. No.: US 2020/0092955 A1
(43) Pub. Date: Mar. 19, 2020

(54) ELECTROMAGNETIC HEATING SYSTEM, METHOD AND DEVICE FOR CONTROLLING THE SAME

(71) Applicants: Deyong JIANG, Foshan (CN); Yunfeng Wang, Foshan (CN); Lutian ZENG, Foshan (CN); Jun LEI, Foshan (CN)

(72) Inventors: Deyong JIANG, Foshan (CN); Yunfeng Wang, Foshan (CN); Lutian ZENG, Foshan (CN); Jun LEI, Foshan (CN)

(21) Appl. No.: 15/750,844

(22) PCT Filed: May 27, 2017
(86) PCT No.: PCT/CN2017/086297

§ 371 Date: Feb. 7, 2018

(30) Foreign Application Priority Data
Nov. 3, 2016 (CN) 201610958337.2

(51) Int. Cl. H05B 6/06; H05B 1/02; F24C 7/00

(52) U.S. Cl. CPC H05B 6/062; F24C 7/00; H05B 1/0202

(57) ABSTRACT

The present disclosure discloses a method for controlling an electromagnetic heating system, including: obtaining a target heating power of the electromagnetic heating system; determining whether the target heating power is less than a preset power; and when the target heating power is less than the preset power, controlling, in each control period, a resonance circuit of the electromagnetic heating system to enter into a discharging stage, a heating stage, and a stop stage successively, in which in the discharging stage, a power switch transistor of the resonance circuit is driven by a first driving voltage such that the power switch transistor works in an amplification state. In this way, a pulse current of the power switch transistor may be restrained, and a low power heating is realized by using a heating mode with a millisecond duty ratio. The present disclosure further discloses a device for controlling an electromagnetic heating system and an electromagnetic heating system.

### FIELD

The present disclosure relates to a household appliances technology field, and more particularly to a method for controlling an electromagnetic heating system, a device for controlling an electromagnetic heating system and an electromagnetic heating system.

### BACKGROUND

In the related art, an electromagnetic resonance circuit with a single IGBT usually adopts a parallel resonance mode, and resonance parameters are set on a premise of realizing a high power operation. As illustrated in FIG. 1, when heating at a high power, a leading voltage is very small and a pulse current of the IGBT is very small when the IGBT is switched on due to the matching of the resonance parameters. However, a problem is that, if a low power is used for heating, as illustrated in FIG. 2, the leading voltage of the IGBT is very high, such that the pulse current of the IGBT is very large and is especially easy to exceed a use threshold of the IGBT, which may damage the IGBT. If low power heating is realized by using a duty ration mode illustrated in FIG. 3, an intermittent heating mode may affect the cooking function, for example, it is easy to overflow when making congee, thus reducing user's cooking experience.

### SUMMARY

Embodiments of the present disclosure seek to solve at least one of the problems existing in the related art to at least some extent. Accordingly, one embodiment provides a method for controlling an electromagnetic heating system, which may restrain a pulse current of a power switch transistor and realize a low power heating.

Another embodiment, provides a device for controlling an electromagnetic heating system.

In yet another embodiment, an electromagnetic heating system is provided.

One embodiment, provides a method for controlling an electromagnetic heating system. The method includes obtaining a target heating power of the electromagnetic heating system; determining whether the target heating power is less than a preset power; and when the target heating power is less than the preset power, controlling, in each control period, a resonance circuit of the electromagnetic heating system to enter into a discharging stage, a heating stage, and a stop stage successively, in which a power switch transistor of the resonance circuit is driven by a first driving voltage in the discharging stage such that the power switch transistor works in an amplification state.

With the method for controlling an electromagnetic heating system provided by embodiments of the present disclosure, the target heating power of the electromagnetic heating system is obtained firstly, and then it is determined whether the target heating power is less than the preset power, if the target heating power is less than the preset power, the resonance circuit of the electromagnetic heating system is controlled to enter into the discharging stage, the heating stage, and the stop stage successively in each control period, in which the power switch transistor of the resonance circuit is driven by the first driving voltage in the discharging stage such that the power switch transistor works in the amplification state. In this way, a pulse current of the power switch transistor may be restrained, and a low power heating may be realized by using a heating mode with a millisecond-level duty ratio, thus improving user experience.

In addition, the method for controlling an electromagnetic heating system according to above embodiments of the present disclosure may further has following additional technical features.

According to an embodiment of the present disclosure, in the heating stage, the power switch transistor is driven by the first driving voltage to switch on for a preset period, and the power switch transistor is driven by a second driving voltage to switch on such that the power switch transistor works in a saturation state; and in the stop stage, the power switch transistor of the resonance circuit is driven by a third driving voltage to switch off.

According to an embodiment of the present disclosure, the above method for controlling an electromagnetic heating system which further includes detecting a zero crossing point of an alternating current provided to the electromagnetic heating system; and in each control period, controlling the resonance circuit to enter into the heating stage and the stop stage according to the zero crossing point.

According to an embodiment of the present disclosure, the first driving voltage is larger than or equal to 5V and is less than or equal to 14.5V, the second driving voltage is larger than or equal to 15V. According to an embodiment of the present disclosure, the preset period is larger than or equal to 0.5 μs and is less than or equal to 5 μs.

According to an embodiment of the present disclosure, the power switch transistor of the resonance circuit is driven by the first driving voltage in the discharging stage to switch on by: providing M pulse signals each with an amplitude of the first driving voltage to the power switch transistor in the discharging stage.

According to an embodiment of the present disclosure, pulse widths of the M pulse signals increase successively, and a difference between pulse widths of two adjacent pulse signals is less than or equal to a preset width threshold, where M is larger than or equal to 5 and M is a positive integer.

According to an embodiment of the present disclosure, the preset width threshold is less than or equal to 2 μs, a pulse width of a first pulse signal is less than or equal to 2 μs.

A second aspect of embodiments of the present disclosure provides a device for controlling an electromagnetic heating system. The system includes a driving device, coupled to a control end of a power switch transistor of the electromagnetic heating system so as to drive the power switch transistor. The system further includes an obtaining device, configured to obtain a target heating power of the electromagnetic heating system, and a control device, coupled to the obtaining device and the driving device respectively. The obtaining device is configured to determine whether the target heating power is less than a preset power, and to control, in each control period, a resonance circuit of the electromagnetic heating system to enter into a discharging stage, a heating stage, and a stop stage successively when the target heating power is less than the preset power, in which in the discharging stage, the driving device is controlled to drive the power switch transistor of the resonance circuit via a first driving voltage such that the power switch transistor works in an amplification state.

With the device for controlling an electromagnetic heating system provided by embodiments of the present disclosure, the target heating power of the electromagnetic heating system is obtained by the obtaining device, and the control device determines whether the target heating power is less than the preset power, if the target heating power is less than the preset power, the control device controls the resonance circuit of the electromagnetic heating system to enter into the discharging stage, the heating stage, and the stop stage successively in each control period, in which in the discharging stage. Further, the driving device is controlled to drive the power switch transistor of the resonance circuit via the first driving voltage such that the power switch transistor works in the amplification state. In this way, a pulse current of the power switch transistor may be restrained, and a low power heating may be realized by using a heating mode with a millisecond-level duty ratio, thus improving user experience.

According to an embodiment of the present disclosure, the control device is further configured to in the heating stage, control the driving device to provide the first driving voltage for driving the power switch transistor to switch on for a preset period and control the driving device to drive the power switch transistor via a second driving voltage to switch on such that the power switch transistor works in a saturation state, and in the stop stage, control the driving device to drive the power switch transistor via a third driving voltage to switch off.

According to an embodiment of the present disclosure, the above device for controlling an electromagnetic heating system further includes a zero crossing point detecting device, coupled to the control device, and configured to detect a zero crossing point of an alternating current provided to the electromagnetic heating system, in which, in each control period, the control device controls the resonance circuit to enter into the heating stage and the stop stage according to the zero crossing point.

According to an embodiment of the present disclosure, the first driving voltage is larger than or equal to 5V and is less than or equal to 14.5V, the second driving voltage is larger than or equal to 15V. According to an embodiment of the present disclosure, the preset period is larger than or equal to 0.5 μs and is less than or equal to 5 μs.

A third aspect of embodiments of the present disclosure provides an electromagnetic heating system, including a device for controlling an electromagnetic heating system provided by above embodiments.

With the electromagnetic heating system provided by embodiments of the present disclosure, by the device for controlling an electromagnetic heating system, a pulse current of the power switch transistor may be restrained, and a low power heating may be realized by using a heating mode with a millisecond-level duty ratio, thus improving user experience.

### BRIEF DESCRIPTION OF THE DRAWINGS

FIG. 1 is a schematic diagram illustrating a wave form for driving an IGBT when an electromagnetic heating system heats at a high power in the related art;

FIG. 2 is a schematic diagram illustrating a wave form for driving an IGBT when an electromagnetic heating system heats with a continuous low power in the related art;

FIG. 3 is a flow chart of a method for controlling an electromagnetic heating system according to embodiments of the present disclosure;

FIG. 4 is a schematic diagram illustrating wave forms of an electromagnetic heating system realizing a low power heating in different duty ratio modes according to a one embodiment of the present disclosure;

FIG. 5 is a schematic diagram illustrating driving wave forms of an electromagnetic heating system realizing a low power heating in a duty ratio mode in three stages according to a one embodiment of the present disclosure;

FIG. 6 is a block diagram illustrating a device for controlling an electromagnetic heating system according to embodiments of the present disclosure;

FIG. 7 is a block diagram illustrating an electromagnetic heating system according to embodiments of the present disclosure; and

FIG. 8 is a schematic diagram illustrating a resonance circuit of an electromagnetic heating system according to an embodiment of the present disclosure.

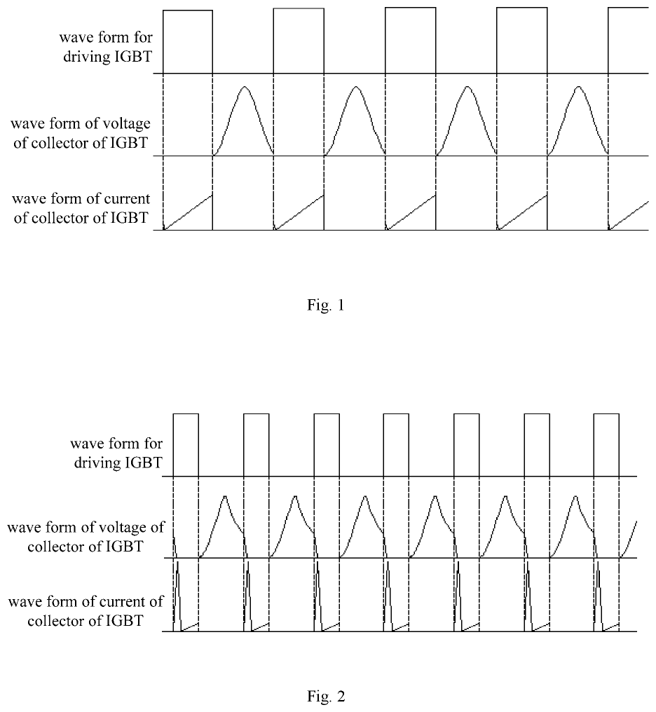

### DETAILED DESCRIPTION

Reference will be made in detail to embodiments of the present disclosure. The same or similar elements and the elements having same or similar functions are denoted by like reference numerals throughout the descriptions. The embodiments described herein with reference to drawings are explanatory, illustrative, and used to generally understand the present disclosure. The embodiments shall not be construed to limit the present disclosure.

In the following, a method and a device for controlling an electromagnetic heating system and an electromagnetic heating system provided by embodiments of the present disclosure are described with reference to drawings.

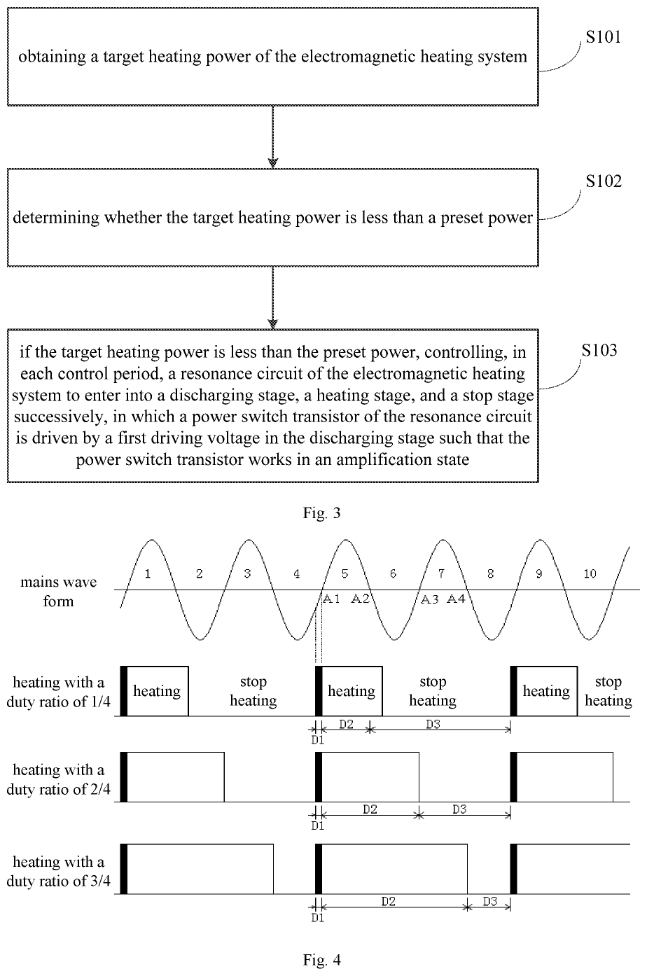

FIG. 3 is a flow chart of a method for controlling an electromagnetic heating system according to embodiments of the present disclosure. As illustrated in FIG. 3, the method for controlling an electromagnetic heating system includes followings.

At block S101, a target heating power W1 of the electromagnetic heating system is obtained.

The target heating power W1 refers to heating power that the electromagnetic heating system may achieve under different cooking parameters. For example, when a user wants to make millet congee, the user may select a congee cooking mode on a control panel of the electromagnetic heating system. The electromagnetic heating system enters the congee cooking mode. The electromagnetic heating system may perform a low power heating with a power of 800 W under the congee cooking mode. At this time, a corresponding target heating power is 800 W.

At block S102, it is determined whether the target heating power W1 is less than a preset power W2.

The preset power W2 may be a power value determined according to an actual situation. When the target heating power W1 is less than the preset power W2, it is determined that the electromagnetic heating system performs the low power heating.

At block 103, if the target heating power W1 is less than the preset power W2, a resonance circuit of the electromagnetic heating system is controlled to enter into a discharging stage D1, a heating stage D2, and a stop stage D3 successively in each control period, in which a power switch transistor of the resonance circuit is driven by a first driving voltage V1 in the discharging stage D1 such that the power switch transistor works in an amplification state.

It should be understood that, as illustrated in FIG. 4, in embodiments of the present disclosure, a duty ratio mode may be used for controlling the electromagnetic heating system to perform the low power heating. That is, in each control period (t1+t2), the electromagnetic heating system may be controlled to heat for a period of t1 firstly and then to stop heating for a period of t2, such that the duty ratio is t1/(t1+t2). For example, when the control period is four half-waves, if the electromagnetic heating system heats for one half-wave and stops heating for three half-waves, the duty ratio is 1/4.

That is to say, when the target heating power W1 is less than the preset power W2, the electromagnetic heating system may perform the low power heating in a duty ratio mode. In each control period, the resonance circuit (such as C2 and L2 in parallel in FIG. 8) is controlled to enter into the discharging stage D1, the heating stage D2, and the stop stage D3 successively. That is, before entering into the heating stage D2, the resonance circuit enters into the discharging stage D1 firstly, such that electric energy stored by a filter capacitor (i.e., C1 in FIG. 8) in a prior stop stage may be released in the discharging stage D1, thus a voltage of a collector of the power switch transistor is basically 0V when the resonance circuit enters into the heating stage D2. In addition, the power switch transistor of the resonance circuit is driven by the first driving voltage V1 in the discharging stage D1, such that the power switch transistor works in the amplification state, thus a pulse current of the power switch transistor may be restrained effectively.

According to a specific example of the present disclosure, a duration of the discharging stage D1 may be larger than or equal to a first preset period, such as 1 ms.

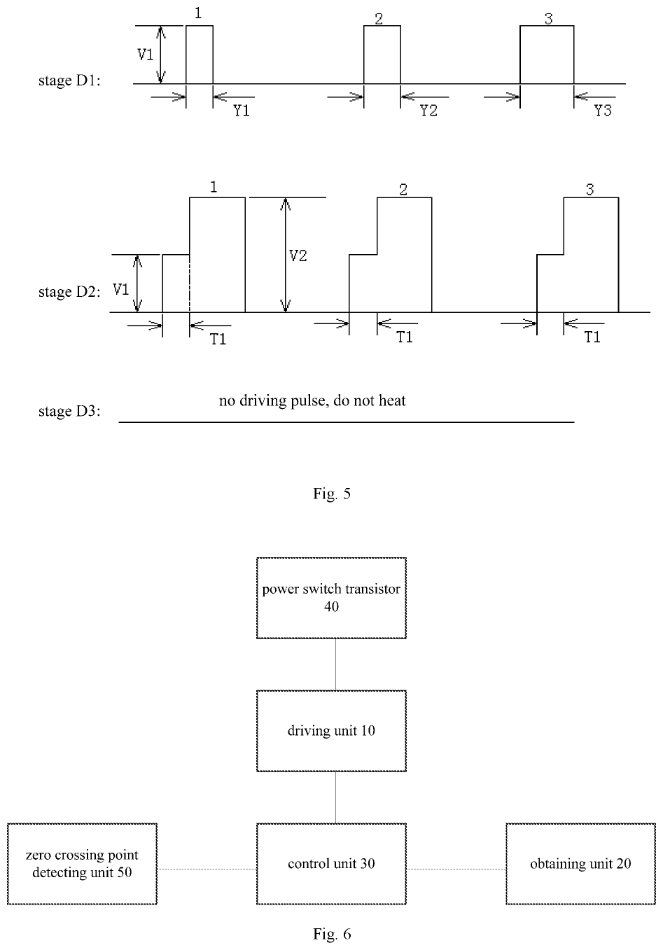

Further, according to an embodiment of the present disclosure, as illustrated in FIG. 5, in the heating stage D2, the power switch transistor is first driven by the first driving voltage V1 to switch on for a preset period T1, and then after the preset period T1, the power switch transistor is driven by a second driving voltage V2 to switch on such that the power switch transistor works in a saturation state. In the stop stage D3, the power switch transistor of the resonance circuit is driven by a third driving voltage V3 to switch off.

That is to say, after the discharging stage D1 is finished, the electromagnetic heating system is controlled to enter into the heating stage D2. In the heating stage D2, as illustrated in FIG. 5, a stepped mode is used for driving the power switch transistor, that is, the first driving voltage V1 is first used for driving the power switch transistor so as to make the power switch transistor work in the amplification state, thus effectively restraining the pulse current of the power switch transistor when it is switched on. In addition, after the preset period T1, the second driving voltage V2 is used for driving the power switch transistor so as to make the power switch transistor work in the saturation conducting state, i.e. the power switch transistor is normally switched on.

In addition, after the heating stage D2 is finished, the electromagnetic heating system is controlled to enter into the stop stage D3. In the stop stage D3, the power switch transistor is controlled to switch off, and the electromagnetic heating system stops heating.

Thereby, above procedures are repeated in each control period to realize the low power heating in the duty ratio mode.

According to an embodiment of the present disclosure, as illustrated in FIG. 4, the method for controlling an electromagnetic heating system according to embodiments of the present disclosure further includes: detecting a zero crossing point of an alternating current provided to the electromagnetic heating system; and in each control period, controlling the resonance circuit to enter into the heating stage and the stop stage according to detected zero crossing point.

For example, as illustrated in FIG. 4, a mode in which the duty ratio is 2/4 is used for heating, four mains half-waves is taken as one control period, the discharging stage D1 is started before a first zero crossing point A1. For example, the first zero crossing point A1 may be pre-estimated, and then a beginning time of the discharging stage D1 is determined according to the pre-estimated first zero crossing point A1 and the duration of the discharging stage D1. The resonance circuit is controlled to enter into the discharging stage D1 at the beginning time. Thereby, after the resonance circuit enters into the discharging stage D1, the power switch transistor of the resonance circuit is driven via the first driving voltage V1 such that the power switch transistor works in the amplification state. When the first zero crossing point A1 is detected, the resonance circuit is controlled to enter into the heating stage D2, that is, a beginning time of the heating stage D2 is near the first zero crossing point A1. The power switch transistor works in a switch state after the first zero crossing point A1, and the stepped mode is used for driving the power switch transistor, thus the pulse current of the power switch transistor when the power switch transistor is switched on is restrained effectively.

A duration of the heating stage D2 is two half-waves, in this situation, when a third zero crossing point A3 is detected, the stop stage D3 is started, the resonance circuit is controlled to stop heating. The stop stage D3 lasts for two half-waves.

According to an embodiment of the present disclosure, the first driving voltage V1 is larger than or equal to 5V and is less than or equal to 14.5V, the second driving voltage V2 is larger than or equal to 15V. In one embodiment of the present disclosure, the power switch transistor may be an IGBT, the first driving voltage V1 may be 9V. When the driving voltage of the IGBT is 9V, a current of a collector of the IGBT is constant, about 22A, and the IGBT works in an amplification state, thus the pulse current is well restrained. The second driving voltage V2 may be 15V. The IGBT works in the saturation state when being driven by the second driving voltage V2. The third driving voltage may be 0V. The IGBT is switched off when being driven by the third driving voltage V3.

According to an embodiment of the present disclosure, the preset period T1 is larger than or equal to 0.5 μs and is less than or equal to 5 μs.

According to an embodiment of the present disclosure, as illustrated in FIG. 5, the power switch transistor of the resonance circuit is driven by the first driving voltage V1 in the discharging stage D1 to switch on by: providing M pulse signals each with an amplitude of the first driving voltage V1 to the power switch transistor in the discharging stage D1.

According to an embodiment of the present disclosure, pulse widths Y of the M pulse signals increase successively, and a difference between pulse widths of two adjacent pulse signals is less than or equal to a preset width threshold N, where M is larger than or equal to 5 and M is a positive integer.

That is, in the discharging stage D1, the power switch transistor is driven by the M pulse signals to switch on and off to release the electric energy stored in the stop stage D3 by the filter capacitor. The pulse widths of the M pulse signals may be Ym, Ym-1, Ym-2, . . . , Y2, Y1. A relationship among the pulse widths of the M pulse signals may be: Ym>=Ym-1+N, Ym-1>=Ym-2+N, Y2 >=Y1+N.

According to an embodiment of the present disclosure, the preset width threshold N is less than or equal to 2 μs, a pulse width Y1 of a first pulse signal is less than or equal to 2 μs.

In conclusion, with the method for controlling an electromagnetic heating system provided by embodiments of the present disclosure, the target heating power of the electromagnetic heating system is obtained firstly, and then it is determined whether the target heating power is less than the preset power, if the target heating power is less than the preset power, the resonance circuit of the electromagnetic heating system is controlled to enter into the discharging stage, the heating stage, and the stop stage successively in each control period, in which the power switch transistor of the resonance circuit is driven by the first driving voltage in the discharging stage to switch on such that the power switch transistor works in the amplification state. In this way, the pulse current of the power switch transistor may be restrained, and a low power heating may be realized by using a heating mode with a millisecond-level duty ratio, thus improving user experience.

In addition, FIG. 6 is a block diagram illustrating a device for controlling an electromagnetic heating system according to embodiments of the present disclosure. As illustrated in FIG. 6, embodiments of the present disclosure further provide a device for controlling an electromagnetic heating system, including a driving device 10, an obtaining device 20, and a control device 30.

The driving device 10 is coupled to a control end of a power switch transistor 10 of the electromagnetic heating system so as to drive the power switch transistor 40. The obtaining device 20 is configured to obtain a target heating power W1 of the electromagnetic heating system. The control device 30 is coupled to the obtaining device 20 and the driving device 10 respectively. The control device 30 is configured to determine whether the target heating power W1 is less than a preset power W2, and to control, in each control period, a resonance circuit of the electromagnetic heating system to enter into a discharging stage D1, a heating stage D2, and a stop stage D3 successively when the target heating power W1 is less than the preset power W2, in which in the discharging stage D1, the driving device 10 is controlled to drive the power switch transistor 40 of the resonance circuit via a first driving voltage V1 to switch on such that the power switch transistor 40 works in an amplification state.

According to an embodiment of the present disclosure, the control device 30 is further configured to: in the heating stage D2, control the driving device 10 to provide the first driving voltage V1 for driving the power switch transistor 40 to switch on for a preset period T1 and control the driving device 10 to drive the power switch transistor 40 via a second driving voltage V2 to switch on such that the power switch transistor 40 works in a saturation state, and in the stop stage D3, control the driving device 10 to drive the power switch transistor 40 via a third driving voltage V3 to switch off.

According to an embodiment of the present disclosure, in combination with FIGS. 4-6, above device for controlling an electromagnetic heating system further includes a zero crossing point detecting device 50. The zero crossing point detecting device 50 is coupled to the control device 30. The zero crossing point detecting device 50 is configured to detect a zero crossing point of an alternating current provided to the electromagnetic heating system. In each control period, the control device 30 controls the resonance circuit to enter into the heating stage and the stop stage according to the zero crossing point.

According to an embodiment of the present disclosure, the first driving voltage V1 is larger than or equal to 5V and is less than or equal to 14.5V, the second driving voltage V2 is larger than or equal to 15V.

In one embodiment of the present disclosure, the power switch transistor may be an IGBT. For example, the first driving voltage V1 is 9V. When the driving voltage of the IGBT is 9V, a current of a collector of the IGBT is constant, about 22A, and the IGBT works in an amplification state, thus the pulse current is well restrained. The second driving voltage V2 may be 15V. The IGBT works in the saturation state under driving of the second driving voltage V2. The third driving voltage may be 0V. The IGBT is switched off under driving of the third driving voltage V3.

According to an embodiment of the present disclosure, the preset period is larger than or equal to 0.5 μs and is less than or equal to 5 μs.

For example, as illustrated in FIG. 4, the preset power is W2, such as 1000W. When the user selects a congee cooking mode of the electromagnetic heating system, for example, assuming that the target heating power corresponds to the congee cooking mode is W1, such as 800 W, the target power W1 is less than the preset power is W2, then control device 30 controls the resonance circuit of the electromagnetic heating system to enter into the discharging stage D1, the heating stage D2, and the stop stage D3 successively in each control period. For example, a mode in which the duty ratio is 2/4 is used for heating, four mains half-waves is taken as one control period, the discharging stage D1 is started before a first zero crossing point A1. And then a beginning time of the discharging stage D1 is determined according to a pre-estimated first zero crossing point A1 and the duration of the discharging stage D1. The resonance circuit is controlled to enter into the discharging stage D1 at the beginning time. Thereby, after the resonance circuit enters into the discharging stage D1, the power switch transistor 40 of the resonance circuit is driven via the first driving voltage V1, such as 9V, such that the power switch transistor 40 works in the amplification state. When the zero crossing point detecting device 50 detects the first zero crossing point A1, the control device 30 controls the resonance circuit to enter into the heating stage D2, that is, a beginning time of the heating stage D2 is near the first zero crossing point A1. The power switch transistor works in a switch state after the first zero crossing point A1, and a stepped mode is used for driving the power switch transistor, thus the pulse current of the power switch transistor is restrained effectively.

In the heating stage D2, the control device 30 first controls the driving device 10 to provide the first driving voltage V1, such as 9V, to drive the power switch transistor 40 to switch on. After the preset period T1, such as 2 μs, the control device 30 controls the driving device 10 to provide the second driving voltage V2 such as 15V, to drive the power switch transistor 40, such that the power switch transistor 40 works in a saturation state, and a first stepped driving pulse is finished. The heating stage D1 is composed by a plurality of stepped driving pulses and its duration is two half-waves. When the zero crossing point detecting device 50 detects the third zero crossing point A3, the stop stage D3 is started, the control device 30 controls the driving device 10 to provide the third driving voltage V3 to drive the power switch transistor 40 to switch off, and the resonance circuit stops heating. The third driving voltage V3 is 0V. The stop stage lasts for two half-waves.

In conclusion, with the device for controlling an electromagnetic heating system provided by embodiments of the present disclosure, the target heating power of the electromagnetic heating system is obtained by the obtaining device, and the control device determines whether the target heating power is less than the preset power, if the target heating power is less than the preset power, the control device controls the resonance circuit of the electromagnetic heating system to enter into the discharging stage, the heating stage, and the stop stage successively in each control period, in which the driving device is controlled to drive the power switch transistor of the resonance circuit to switch on via the first driving voltage in the discharging stage such that the power switch transistor works in the amplification state. In this way, the pulse current of the power switch transistor may be restrained, and a low power heating may be realized by using a heating mode with a millisecond-level duty ratio, thus improving user experience.

In addition, embodiments of the present disclosure further provide an electromagnetic heating system.

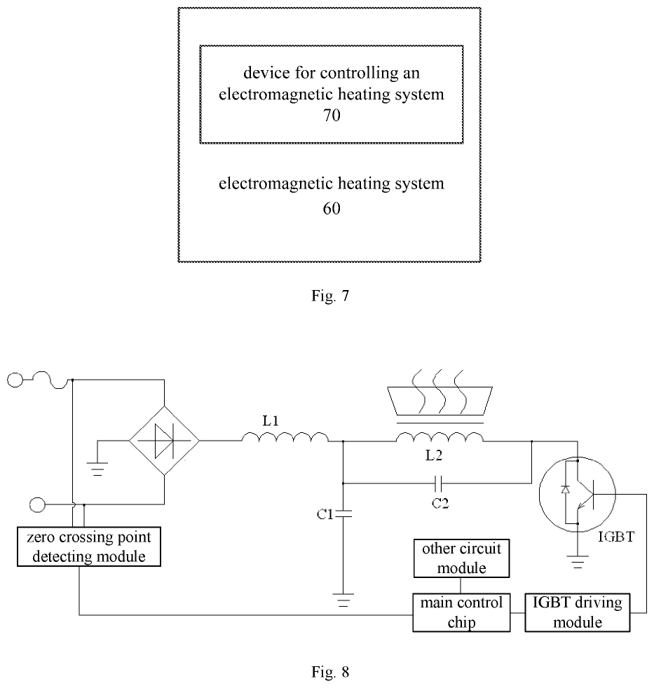

FIG. 7 is a block diagram illustrating an electromagnetic heating system according to embodiments of the present disclosure. As illustrated in FIG. 7, the electromagnetic heating system 60 includes the device 70 for controlling an electromagnetic heating system according to above embodiments.

With the electromagnetic heating system provided by embodiments of the present disclosure, by the device for controlling an electromagnetic heating system, a pulse current of the power switch transistor may be restrained, and a low power heating may be realized by using a heating mode with a millisecond-level duty ratio, thus improving user experience.

In the specification, it is to be understood that terms such as “central,” “longitudinal,” “lateral,” “length,” “width,” “thickness,” “upper,” “lower,” “front,” “rear,” “left,” “right,” “vertical,” “horizontal,” “top,” “bottom,” “inner,” “outer,” “clockwise,” and “counterclockwise” should be construed to refer to the orientation as then described or as shown in the drawings under discussion. These relative terms are for convenience of description and do not require that the present invention be constructed or operated in a particular orientation.

In addition, terms such as “first” and “second” are used herein for purposes of description and are not intended to indicate or imply relative importance or significance. Thus, the feature defined with “first” and “second” may comprise one or more this feature. In the description of the present disclosure, “a plurality of” means two or more than two, such as two or three, unless specified otherwise.

In the present invention, unless specified or limited otherwise, the terms “mounted,” “connected,” “coupled,” “fixed” and the like are used broadly, and may be, for example, fixed connections, detachable connections, or integral connections; may also be mechanical or electrical connections; may also be direct connections or indirect connections via intervening structures; may also be inner communications of two elements.

In the present invention, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed there between. Furthermore, a first feature “on,” “above,” or “on top of” a second feature may include an embodiment in which the first feature is right or obliquely “on,” “above,” or “on top of” the second feature, or just means that the first feature is at a height higher than that of the second feature; while a first feature “below,” “under,” or “on bottom of” a second feature may include an embodiment in which the first feature is right or obliquely “below,” “under,” or “on bottom of” the second feature, or just means that the first feature is at a height lower than that of the second feature.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

1. A method, comprising:
obtaining a target heating power of an electromagnetic heating system;
determining whether the target heating power is less than a preset power; and
when the target heating power is less than the preset power, controlling, in each control period, a resonance circuit of the electromagnetic heating system to enter into a discharging stage, a heating stage, and a stop stage successively, wherein a power switch transistor of the resonance circuit is driven by a first driving voltage in the discharging stage, wherein the power switch transistor functions in an amplification state.

2. The method according to claim 1, wherein,
in the heating stage, the power switch transistor is driven by the first driving voltage to switch on for a preset period, and the power switch transistor is driven by a second driving voltage to switch on the power switch transistor, wherein the power switch transistor functions in a saturation state; and
in the stop stage, the power switch transistor of the resonance circuit is driven by a third driving voltage to switch off.

3. The method according to claim 1, further comprising:
detecting a zero crossing point of an alternating current provided to the electromagnetic heating system; and
in each control period, controlling the resonance circuit to enter into the heating stage and the stop stage according to the zero crossing point.

4. The method according to claim 3, wherein the first driving voltage is between 5V and 14.5V, and the second driving voltage is greater than or equal to 15V.

5. The method according to claim 3, wherein the preset period is between 0.5 μs and 5 μs.

6. The method according to claim 1, wherein the power switch transistor of the resonance circuit is driven by the first driving voltage in the discharging stage to switch on by:
providing M pulse signals each with an amplitude of the first driving voltage to the power switch transistor in the discharging stage.

7. The method according to claim 6, wherein pulse widths of the M pulse signals increase successively, and a difference between pulse widths of two adjacent pulse signals is less than or equal to a preset width threshold, where M is larger than or equal to 5 and M is a positive integer.

8. The method according to claim 7, wherein the preset width threshold is less than or equal to 2 μs, a pulse width of a first pulse signal is less than or equal to 2 μs.

9. A device comprising:
a driving device, coupled to a control end of a power switch transistor of an electromagnetic heating system so as to drive the power switch transistor;
an obtaining device, configured to obtain a target heating power of the electromagnetic heating system; and
a control device, coupled to the obtaining device and the driving device respectively, and configured to determine whether the target heating power is less than a preset power, and to control, in each control period, a resonance circuit of the electromagnetic heating system to enter into a discharging stage, a heating stage, and a stop stage successively when the target heating power is less than the preset power, wherein in the discharging stage, the driving device is controlled to drive the power switch transistor of the resonance circuit via a first driving voltage, wherein the power switch transistor functions in an amplification state.

10. The device according to claim 9, wherein the control device is further configured to:
in the heating stage, control the driving device to provide the first driving voltage for driving the power switch transistor to switch on for a preset period, and control the driving device to drive the power switch transistor via a second driving voltage to switch on such that the power switch transistor works in a saturation state, and
in the stop stage, control the driving device to drive the power switch transistor via a third driving voltage to switch off

11. The device according to claim 9, further comprising:
a zero crossing point detecting device, coupled to the control device, and configured to detect a zero crossing point of an alternating current provided to the electromagnetic heating system, wherein, in each control period, the control device controls the resonance circuit to enter into the heating stage and the stop stage according to the zero crossing point.

12. The device according to claim 11, wherein the first driving voltage is between 5V and 14.5V, and the second driving voltage is greater than or equal to 15V.

13. The device according to claim 11, wherein the preset period is greater than or equal to 0.5 μs and is less than or equal to 5 μs.

14. An electromagnetic heating system, comprising:
an electromagnetic heating device including:
a driving device, coupled to a control end of a power switch transistor of an electromagnetic heating system so as to drive the power switch transistor;
an obtaining device, configured to obtain a target heating power of the electromagnetic heating system; and
a control device, coupled to the obtaining device and the driving device respectively, and configured to determine whether the target heating power is less than a preset power, and to control, in each control period, a resonance circuit of the electromagnetic heating system to enter into a discharging stage, a heating stage, and a stop stage successively when the target heating power is less than the preset power, wherein in the discharging stage, the driving device is controlled to drive the power switch transistor of the resonance circuit via a first driving voltage, wherein the power switch transistor functions in an amplification state.
